(19) United States
(12) Patent Application Publication
(10) Pub. No.: US 2003/0120572 A1
(43) Pub. Date: Jun. 26, 2003

(54) Monitoring and representing a financial target

(75) Inventors: Lynne M. Coventry, Edinburgh (GB); Antonella De Angeli, Dundee (GB)

Correspondence Address: Michael Chan, NCR Corporation, 1700 South Patterson Blvd., Dayton, OH, 45479-0001, US

(73) Assignee: NCR Corporation, Dayton, OH

(21) Appl. No.: 10/325,343

(22) Filed: Dec. 19, 2002

(30) Foreign Application Priority Data
Dec. 20, 2001 (GB) 0130478.1

(51) Int. Cl. G06F 17/60

(52) U.S. Cl. 705/35

(57) ABSTRACT

A method is described for monitoring a financial target of a user using a self service terminal (SST), and for assisting the user in meeting the target. The method comprises obtaining details of a user's target (such as a particular desired purchase) together with a visual representation of that target whenever the user wishes to conduct a financial transaction with the SST. The financial status of the user, including a savings regime or budget, is obtained and compared with the target to determine a proximity to the target. When the user requests a financial transaction be performed, the proximity to the target after the transaction is performed is calculated and compared with the original proximity. The visual representation of the target is then modified to represent the change in proximity, and displayed to the user to show the effect of the requested transaction on the savings regime. The user is then requested to confirm or cancel the transaction.

### BACKGROUND OF THE INVENTION

The present invention relates to a method and to an apparatus for monitoring and representing a financial target. In particular, the invention relates to a method and to an apparatus for assisting users in monitoring their progress towards or proximity to a predetermined financial target. Certain aspects of the invention further relate to a self service terminal (SST) for use in monitoring a financial target.

It is of great benefit to individuals to be in a position to manage their money and finances in a sensible manner, and to be able to guide their finances towards a particular goal. For example, an individual may wish to set aside some of their monthly income towards eventual purchase of a motor car, or the like. One method of doing this is simply through organization, and rigorously setting and meeting financial limits and goals; for example, calculating the individual's total income and expenditure, and planning to transfer a predetermined excess amount each month into a specific savings account.

However, many people may find it difficult to set a firm budget and to conform to that budget every month. For example, the degree of planning and organization necessary to calculate a reliable budget and to ensure that the predetermined monthly savings payment is present each month can deter some people from embarking upon such a project. Further, even the most self-disciplined of savers may nonetheless require extra funds to meet unexpected expenditure, or for emergencies. The possibility of such emergencies may also deter some individuals from committing to a particular savings plan. Finally, not every saver can be assured of retaining a particular excess of spare funds, or even any excess funds, each month, and so be unable to plan a consistent savings regime. All of these problems can make it difficult for even the most well-intentioned individual to set and meet a specific financial target.

Furthermore, many potential savers find that they do not wish to plan and manage all of their budget in the necessary detail, but would rather manage only a portion of their finances in order to meet a particular goal. Many other potential savers do not wish or are not able to commit to regular savings payments, but would nonetheless wish to save some money where possible toward a particular specific goal.

It may also be difficult for some individuals to continue to budget and to save for a particular goal on their own, without encouragement or assistance from others. Further, the possible lack of noticeable progress towards a specific goal other than a monthly bank statement with a slowly increasing balance can be demoralizing for an individual, and may result in a loss of enthusiasm for the savings scheme, despite still wishing to achieve the predetermined target.

A number of aids to budgeting and saving have been developed for the computer-literate saver, such as Microsoft Money, Quicken, and the like. However, these are by definition aimed at the computer-using savers, who are more likely than some to be motivated and able to aim at financial targets. Further, current budgeting computer programs will assist a user in drawing up and planning a budget and savings plan, but will not offer any assistance in actually contributing to and staying with the savings scheme. In addition, it is typical for such programs to require a user to set targets for every aspect of their financial affairs, and for the user to collate and manage all of the user's financial information themselves. Thus, such programs do not generally assist a user to reach towards or to meet a chosen target, and do not allow only one specific target, such as purchase of a motor vehicle, to be pursued without reference to a whole range of other targets, which may discourage potential users from seeking to meet these targets.

### SUMMARY OF THE INVENTION

It is among the objects of embodiments of the present invention to obviate or alleviate these and other disadvantages of known financial management techniques. This is achieved, in part, in certain embodiments of the invention, by providing a method and an apparatus whereby a user may be presented with a visualization of their progress towards a predetermined financial target, and feedback as to the effect of financial transactions on that progress.

According to a first aspect of the present invention, there is provided a method of monitoring and representing a user's financial target, the method comprising the steps of:

identifying a user's financial target to be achieved;

identifying a visual representation of the financial target;

determining the user's financial status, and calculating the proximity of the financial status to the target;

receiving instructions from the user of a financial transaction to be executed;

determining the effect of the financial transaction on the proximity of the user's financial status to the target;

modifying the visual representation of the financial target in accordance with the effect of the financial transaction on the proximity of the user's financial status to the target; and

displaying the modified visual representation of the financial target to the user.

Thus, the present invention allows a particular target to be represented by a visual representation of that target—for example, if the target is for the user to save to buy a new car, the representation may be an image of that car; if the user is saving towards a holiday, the representation may be an image of a tropical beach scene. When the user instructs a financial transaction, the effect of that transaction on the user's approach to the target may be calculated, and the visual representation modified accordingly. For example, in a relatively simple implementation of the present method, if the user becomes less able to afford their desired holiday, the image of the tropical beach scene may be modified to appear smaller, or may be displayed at a lower resolution to indicate distance from the target. Conversely, as the user becomes more able to afford their holiday, the image may become larger, or in higher resolution. More complex representations may also be used: for example, if the user is saving for a car, the image of the car may be modified to illustrate a different type of car depending on the proximity to the target. An old or run-down vehicle may be shown if the user is distant from the target, while a new or luxury car may be used to denote that the user is nearing the target.

A user's financial status may include simple details of the user's available funds. In this case, the proximity of the user's financial status to a target may be a simple reflection of the user's available funds compared with the cost of the target. In more complex embodiments of the invention, the target or financial status may also include details of a financial budget or savings regime, including estimated income and expenditure, and the like.

In this case, the proximity of the user's financial status to the target may be calculated to represent the user's ability to meet the target by conforming to that budget or regime. Thus, if the user wishes to withdraw funds from an account, this may not necessarily affect the proximity to the target if the user is still able to conform to the budget to meet the target.

Calculation of the proximity of a user's financial status to the target may be performed in a number of ways, which will be apparent to the skilled person. For example, many commercially-available financial computer programs (such as Microsoft Money, or Quicken) allow determination of the status of a budget or savings regime, and hence proximity-to a target. Simple mathematical algorithms may also be used; for example, if an average rate of growth of a user's account balance is known, then it is a relatively straightforward task to calculate the time until the user will have sufficient funds to purchase a particular item, or to meet a particular task. The bringing forward or backward of this calculated time will indicate that the user is nearing or getting further from their target. More simply, a transaction which increases a user's account balance may be taken to be approaching the financial target, while a decrease in balance will make the target less achievable; this simplified method will however typically be less accurate or flexible than those methods making use of a savings regime or budget. The precise method of calculation of the user's proximity to the target is not essential to the operation of the present invention.

The step of identifying a user's financial target may comprise retrieving details of the financial target from a database. This may conveniently be a remote database, for example, hosted on a server operated by a financial service provider such as a bank. The financial target itself is preferably predetermined by the user (for example, purchase of a particular car by a particular date; saving for a holiday; or a more long-term target such as saving for retirement); this may take place when setting up the facility to operate the present method or may be selected at a later date. Preferred embodiments of the invention also include a savings regime or budget negotiated by the user with their financial service provider, by means of which the user may meet their target. In preferred embodiments of the invention, the particular target may be any selected by the user; in certain embodiments, however, the user may be restricted to choose a target from a limited predetermined range of targets. This restriction allows the setting of targets to be conducted in a largely automated manner without requiring human intervention in the setting of targets. For example, a financial service provider may make available a choice of the fifty or so most common financial targets to be selected. Determination of a budget or savings regime may also be automated; however it is preferred that some human involvement takes place to allow a more flexible approach.

The step of identifying a visual representation of the financial target may comprise retrieving details of the visual representation from a database; conveniently the same database as contains details of the financial target itself. The visual representation may also be predetermined by the user; again, in the same manner as the financial target, the representation may be selected from a restricted range of possibilities or may be anything the user may wish. For example, the user may provide their own image to be used when setting up the facility to operate the present invention.

The method may further comprise the step of identifying the user prior to identification of the financial target and representation. This allows the correct financial target and representation to be retrieved from a database or other store containing details of multiple users. The user may be identified by any suitable method; for example, use of an identification token such as a card, an identification password or number, an encrypted electronic token or the like, or a biometrics identification token.

The step of determining the user's financial status may comprise contacting a financial service provider to obtain the status. Alternatively, where the service provider is operating the present method, the financial status may be determined from a remote server operated by the service provider. The contact may take place via a telecommunications network, a computer network, or the like. The financial status of the user which is obtained may be simply the balance of the user's financial account with that service provider, or may be more complex, for example, including details of past and projected income and past and projected expenditure over a future time period.

The step of receiving instructions may comprise receiving instructions via a user interface. The user interface may be part of a self service terminal (SST), or a mobile telecommunications device, a personal digital assistant (PDA), a computer terminal on a computer network, or the like.

The step of determining the effect of the transaction on the proximity to the target may comprise modeling the user's financial status after the transaction has been executed, calculating the proximity of the modeled status to the target, and comparing the proximity of the modeled status to the target with the proximity of the previous status to the target.

Modifications of the visual representation may be predetermined—for example, when the visual representation is initially identified, a number of alternative representations may also be identified each of which is associated with a particular change in proximity to the target. Thus, once the change in proximity is determined, an appropriate modified representation may be selected from the alternatives and displayed. Alternatively, the modified representation may be calculated according to one or more predetermined algorithms—for example, a visual representation may be modified by being ‘pixilated’ to an extent proportional to the change in proximity, with the modified representation being calculated immediately prior to display. The modified representation need not of course be a simple static image; animations and films may also be used, which may further include sound or other sensory data.

The step of displaying the modified representation preferably comprises displaying the modified representation on a display screen of a self service terminal (SST).

Alternatively, the modified representation may be displayed on a screen of a personal digital assistant (PDA), mobile telecommunications device, computer, or the like. The modified representation may be further modified or determined according to the method of display of the modified image—for example, a more detailed image may be shown on an SST display screen than would be possible on a mobile telecommunications device.

The method may further comprise the step of displaying the unmodified visual representation to the user. This may be displayed before or at the same time as the modified representation, so allowing the user to more directly see the effects of the financial transaction. In certain embodiments of the invention, a number of intermediate representations may be displayed between the unmodified and the modified representation;

this allows the unmodified representation to be displayed ‘morphing’ or otherwise animatedly changing into the modified representation.

The method may further comprise the step of executing the financial transaction.

The method may further comprise the step of requesting the user to confirm execution of the financial transaction after displaying the modified representation. This allows the user an opportunity to cancel the transaction once they have seen the effect of the transaction on the target; hence the present invention assists users in keeping to financial targets.

Where the user's financial status meets or exceeds the target, the method may further comprise the step of requesting the user to set a new financial target; alternatively, the existing target may be modified (for example, to save for a more expensive holiday, or the like). Alternatively, or in addition, the method may further comprise the step of offering the user the opportunity to conduct a financial transaction in accordance with their target. For example, where the target is to save for a particular car, the user may be offered the option of purchasing the car once the target is met. As an incentive to users to set and to meet targets, and to conform to a planned savings regime, the method may further comprise the step of offering financial incentives or price reductions on goods or services purchased in this way; thus, not only do users obtain motivation and assistance in meeting their targets, they also have an incentive to do so to reduce the overall cost of the targets. Providers of goods or services may be charged a fee for inclusion in this method, since they will obtain sales they would not otherwise have made.

Where the user's financial status does not yet meet or exceed the target, the method may comprise the step of offering the user a lower target, or of offering the user the opportunity to conduct a financial transaction in accordance with a lower target. For example, where the target is to save for a particular car, the user may be offered the opportunity of purchasing a less expensive car rather than continuing to pursue the original target. Again, providers of goods or services may be charged a fee for inclusion in this method. The method may in addition comprise the step of offering an incentive to conduct a transaction in accordance with a lower target; for example, a time-limited reduced price or the like.

The method may further comprise the step of monitoring and representing a plurality of targets simultaneously. Where multiple targets are set, there may be some interaction between each target; for example, increased proximity to one target may mean decreased proximity to an alternative target. Thus, multiple representations may be displayed simultaneously, to allow the user to see the direct effect of meeting one target on the possibility of meeting another target. For example, where a user wishes to transfer funds from an account earmarked for saving for a car into a designated ‘holiday’ savings account, an image of a car may be displayed reducing in size as a tropical beachscape is increased in size. The method may also comprise the step of weighting the various targets in accordance with their importance to the user; the user may further be offered the opportunity of modifying these weightings to see the effect of promoting certain targets at the expense of others, or as the user's personal goals change over time. The display of each of the targets may also represent the weightings given to each target; for example, more important targets may be larger in size, or displayed in the foreground, while less important targets are smaller or remain in the background. Further, more immediate targets may be displayed in the foreground or otherwise displayed to represent their immediacy.

According to a second aspect of the present invention, there is provided a method of monitoring a user's financial target by means of a self service terminal (SST), the method comprising the steps of:

identifying a user by means of a user identification token;

communicating with a remote server to obtain details of a financial target associated with the user's identity, and a visual representation of that target;

obtaining details of the user's financial status from a financial service provider;

calculating the proximity of the user's financial status to the user's target;

receiving instructions from the user of a financial transaction to be executed;

determining a change in proximity to the target which would result from execution of the financial transaction;

modifying the visual representation of the target dependent on the change in proximity; and

displaying the modified representation to the user.

According to a further aspect of the present invention, there is provided a method of monitoring a user's financial target, the method comprising:

receiving details of a user's identity from a remote computing device; retrieving a financial target and a visual representation of the target, and a financial status associated with the user's identity;

calculating the proximity of the user's financial status to the financial target;

receiving details of a financial transaction to be executed from a remote computing device;

calculating the effect of executing the transaction on the proximity of the user's financial status to the financial target;

modifying the visual representation of the financial target in accordance with the effect of the transaction on the proximity to the target; and

transferring the modified visual representation to a remote computing device for display to the user.

The remote computing device may be a personal digital assistant (PDA), a mobile telecommunications device, a computer terminal on a network, a self-service terminal, or the like.

According to a further aspect of the present invention, there is provided a self service terminal (SST), comprising:

user identification means for reading a user identification token to identify a user;

communication means for communicating with a remote server;

memory storage means for storing data concerning a user's financial target, a visual representation of that target, and a user's financial status obtained from a remote server;

first data processing means for calculating the proximity of the user's financial status to the target;

user interaction means for receiving instructions of financial transactions to be executed from a user;

second data processing means for calculating the effect of the financial transaction on the user's financial status and the proximity to the target;

image processing means for modifying the visual representation of the target in accordance with the proximity to the target; and

image display means for displaying a visual representation of the target to a user.

The user identification means may comprise a magnetic card reader, a smart card reader, an infra-red or other electromagnetic communications device, a biometrics reading device, a numeric or alphanumeric keypad, or the like.

The communication means preferably comprises a communications network connection, such as a fiber optic or electrically conductive cable or the like. Wireless communications means may also be used.

The user interaction means may comprise a touch sensitive screen, a numeric or alphanumeric keypad, an infra-red or other electromagnetic communications device, a voice-recognition device, or the like.

The first and second data processing means, and/or the image processing means, may be provided as separate components, or may be a common computing device or the like.

### BRIEF DESCRIPTION OF THE DRAWINGS

These and other aspects of the present invention will now be described by way of example only and with reference to the accompanying drawings, in which:

FIG. 1 is a flowchart illustrating an embodiment of the method of the present invention; and

FIG. 2 shows a self service terminal (SST) in accordance with an embodiment of the present invention.

### DETAILED DESCRIPTION

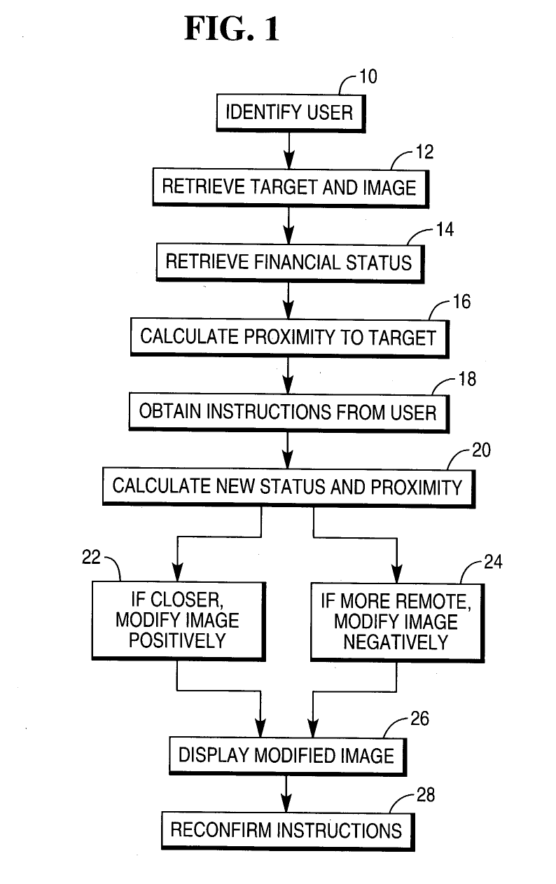

Referring first of all to FIG. 1, this shows a flow chart illustrating an embodiment of a method for monitoring a financial target in accordance with the present invention. Prior to the sequence of steps shown in FIG. 1, a user will first of all set up the facility to monitor a financial target with their financial service provider, such as a bank. The user will inform the bank of the target which they wish to meet, for example, to purchase a car costing £5,000 in one year's time. The user also selects an image representing that target; for example, a picture of the car in question. The image may be selected from a restricted range of images held by the financial service provider, or the user may supply their own image, for example, a photograph or computer image file of the car. Details of the target and the image are then stored by the financial service provider in their database, together with information identifying the user. An appropriate savings regime is also negotiated with the user to allow the target to be met; details of the regime are also stored by the financial service provider together with their records of the user's account status. The initial setting up of these details may be carried out by a computer-implemented method, for example, online via the internet, or via a self service terminal (SST); or may be carried out manually, for example, by allowing the user to speak to a bank employee in person.

When the user wishes to conduct a financial transaction, and thus requires some monitoring of their approach to the target, the method proceeds as follows. The following description will assume that the user is making use of an SST to access their details, although it will be apparent to the skilled person that the method may be implemented in a number of other formats, for example, by home computer banking, mobile telephone banking, via a PDA, and the like.

The user first of all identifies themselves to the SST 10. This may be conducted by means of an identification token, such as a smart card or the like, in combination with a personal identification number (PIN), such as is used with conventional SSTs. Alternative identification means may of course be used, for example, biometrics techniques. Use of a physical identification token allows further fundraising and licensing opportunities to be exploited by the financial service provider. For example, a smart card may be produced having the user's selected visual representation of their target thereon. Such cards may also be sponsored by a particular manufacturer or business: for example, the card may be sponsored by a particular car manufacturer or retailer, and so may display an image of the car together with the manufacturer or retailer logo. The user is thus reminded of their target and a possible retailer from whom to purchase their goal each time the card is used.

Once the user's claimed identity is confirmed by the SST, the financial service provider is contacted 12 with details of the user's identity to retrieve the previously-stored information regarding the user's target and the representation of the target. In addition, the financial status of the user is also obtained 14 from the service provider; the status may be in the form of the user's account balance, or may include additional financial details such as regular income and expenditure, other debts, and the like. The SST then calculates 16 a score indicating the proximity of the user's financial status to the target; the score may be a simple percentage of the target achieved, or may be any suitable indication of proximity. In this example, the score will represent the likelihood of the user meeting their target by the given target date, in view of their savings regime and current spending habits. The SST will calculate the proximity using any suitable algorithm or computer program; the precise implementation is not essential to the working of the invention.

The SST then allows the user to enter instructions 18 regarding a financial transaction to be executed—for example, the user may wish to withdraw some cash from their account, or to pay a bill or invoice; or may wish to deposit some funds into the account, or transfer money from one account to another. The instructions may be obtained in any convenient manner; where the invention is implemented by means of an SST, this will typically comprise the use of a touch screen display or alphanumeric keypad to navigate a series of possible menu choices.

Once the instructions have been obtained, the SST then recalculates 20 a modified financial status of the user which would be the status if the transaction were executed (for example, the new account balance), and the modified proximity of the user to their target.

The original and modified proximities are then compared. If the new proximity is closer to the target than the original proximity, then the image is modified positively 22 to indicate this; for example, the image may be increased in size. If the new proximity is more remote from the target, then the image is modified negatively 24, for example, by reducing it in size.

The modified image is then displayed 26 by the SST to the user, to allow the user to see the effects of the requested transaction on their target; to make this clearer, the original image may also be displayed alongside or before the modified image. The user is then requested 28 to confirm the instructions to execute the transaction, so offering the user the opportunity to cancel the transaction if they decide to continue reaching toward their target.

The manner in which the image is modified in steps 22 and 24 may be in accordance with a predetermined algorithm; for example, enlarging or reducing in size dependent on the change in proximity to the target, or altering the resolution of the image; or may be selected by the user when setting up their image with the service provider, for example, a series of different images may be used to denote different degrees of proximity to the target. Details of the relevant modifications to be made to the image may be obtained from the financial service provider at the same time as the image itself is obtained.

Referring now to FIG. 2, this shows a self service terminal (SST) 30 in accordance with an embodiment of the present invention. The SST 30 includes a casing 32 within which is contained a computer processor 34 which includes a data processor 36, an image processor 38, and a communications unit 40. The communications unit 40 is connected via data transfer cable 42 to a remote server 44 operated by the financial service provider. A memory storage device 46 for storing working data from the computer processor 34 and data retrieved from the remote server 44 is also contained within the casing 32, and is connected to the computer processor 34.

Mounted within the casing 32 and on an outer fascia thereof for interaction with a user are a display screen 48, a smart card reader 50, and an alphanumeric keypad 52. Each of these is connected to and controlled by the computer processor 34.

In use, the SST 30 can be used to implement the method shown in FIG. 1 as follows. A user enters a smart card into the reader 50, and enters a PIN by means of the keypad 52. The processor 34 then communicates with the remote server 44 to retrieve details of the user's financial status, the target, and the image. These are then stored in the memory storage 46. The data processor 36 is used to calculate the proximity of the user's financial status to the target. Instructions are received from the user by means of the keypad 52 and the display screen 48, and stored in the memory storage 46. The data processor then calculates the effect of the instructions on the financial status and the proximity to the target, while the image processor 38 then modifies the image in the memory storage 46 in accordance with the change in proximity. Display screen 48 is then used to display the modified image, while the user is requested to confirm the instructed transaction by means of the keypad 52. If the user wishes to proceed with the transaction, the communications unit 40 transfers the instructions to the financial service provider remote server 44, which then proceeds to implement the instructions. The user's smart card is then returned from the reader 50, and the interaction with the SST ends.

In certain embodiments of the invention, the modified image may also be transferred to the remote server 44 if the instructions are executed, to replace the original image. In this way the image will continuously be modified and updated to reflect the changing proximity of the user to their target.

It will also be apparent to the skilled person that the method of the present invention may be implemented other than with an SST, for example, by means of a mobile computing device such as a PDA or the like. In this case, the necessary calculations and processing may be conducted by the remote server, and only the results of the processing transferred to the mobile device for display to the user.

What is claimed is:

1. A method of monitoring and representing a user's financial target, the method comprising the steps of:
identifying a user's financial target to be achieved;
identifying a visual representation of the financial target;
determining the user's financial status, and calculating the proximity of the financial status to the financial target;
receiving instructions from the user of a financial transaction to be executed;
determining the effect of the financial transaction on the proximity of the user's financial status to the financial target;
modifying the visual representation of the financial target in accordance with the effect of the financial transaction on the proximity of the user's financial status to the target; and
displaying the modified visual representation of the financial target to the user.

2. A method according to claim 1, wherein the step of identifying a user's financial target comprises retrieving details of the financial target from a database.

3. A method according to claim 1, further comprising the step of identifying the user prior to identification of the financial target and representation.

4. A method according to claim 1, wherein the step of determining the user's financial status comprises contacting a financial service provider to obtain the status.

5. A method according to claim 1, wherein the step of receiving instructions comprises receiving instructions via a user interface.

6. A method according to claim 1, wherein the step of determining the effect of the transaction on the proximity to the target comprises modeling the user's financial status after the transaction has been executed, calculating the proximity of the modeled status to the target, and comparing the proximity of the modeled status to the target with the proximity of the previous status to the target.

7. A method according to claim 1, further comprising the step of displaying the unmodified visual representation to the user.

8. A method according to claim 1, further comprising the step of requesting the user to confirm execution of the financial transaction after displaying the modified representation.

9. A method of monitoring and representing a user's financial target by means of a self service terminal, the method comprising the steps of:
identifying a user by means of a user identification token;
communicating with a remote server to obtain details of a financial target associated with the user's identity, and a visual representation of that target;
obtaining details of the user's financial status from a financial service provider;
calculating the proximity of the user's financial status to the user's target;
receiving instructions from the user of a financial transaction to be executed;
determining a change in proximity to the target which would result from execution of the financial transaction;
modifying the visual representation of the target dependent on the change in proximity; and
displaying the modified representation to the user.

10. A self service terminal comprising:
user identification means for reading a user identification token to identify a user;
communication means for communicating with a remote server;
memory storage means for storing data concerning a user's financial target, a visual representation of that target, and a user's financial status obtained from a remote server;
first data processing means for calculating the proximity of the user's financial status to the target;
user interaction means for receiving instructions of financial transactions to be executed from a user;
second data processing means for calculating the effect of the financial transaction on the user's financial status and the proximity to the target;
image processing means for modifying the visual representation of the target in accordance with the proximity to the target; and
image display means for displaying a visual representation of the target to a user.

11. An apparatus for monitoring and representing a user's financial target, the apparatus comprising:
means for identifying a user's financial target to be achieved;
means for identifying a visual representation of the financial target;
means for determining the user's financial status, and calculating the proximity of the financial status to the financial target;
means for receiving instructions from the user of a financial transaction to be executed;
means for determining the effect of the financial transaction on the proximity of the user's financial status to the financial target;
means for modifying the visual representation of the financial target in accordance with the effect of the financial transaction on the proximity of the user's financial status to the target; and
means for displaying the modified visual representation of the financial target to the user.

12. An apparatus according to claim 11, wherein the means for identifying a user's financial target includes means for retrieving details of the financial target from a database.

13. An apparatus according to claim 11, further comprising means for identifying the user prior to identification of the financial target and representation.

14. An apparatus according to claim 11, wherein the means for determining the user's financial status includes means for contacting a financial service provider to obtain the status.

15. An apparatus according to claim 11, wherein the means for receiving instructions includes means for receiving instructions via a user interface.

16. An apparatus according to claim 11, wherein the means for determining the effect of the transaction on the proximity to the target includes means for modeling the user's financial status after the transaction has been executed, calculating the proximity of the modeled status to the target, and comparing the proximity of the modeled status to the target with the proximity of the previous status to the target.

17. An apparatus according to claim 11, further comprising means for displaying the unmodified visual representation to the user.

18. An apparatus according to claim 11, further comprising means for requesting the user to confirm execution of the financial transaction after displaying the modified representation.
